(19) United States
(12) Patent Application Publication
(10) Pub. No.: US 2025/0244570 A1
(43) Pub. Date: Jul. 31, 2025

(54) COVER GLASS THICKNESS CORRECTION BY TUBE LENS PLACEMENT

(71) Applicant: Beckman Coulter, Inc., Brea, CA (US)

(72) Inventors: Jozef SOFKA, Miami, FL (US); Karan Patel, Hollywood, FL (US); Vinay Prathapan, Miami, FL (US)

(21) Appl. No.: 18/849,176

(22) PCT Filed: Mar. 21, 2023
(86) PCT No.: PCT/US2023/015748

§ 371 Date: Sep. 20, 2024

Related U.S. Application Data
(60) Provisional application No. 63/321,996, filed on Mar. 21, 2022.

(51) Int. Cl. G02B 21/36; G01N 21/05; G02B 7/02; G02B 21/02

(52) U.S. Cl. CPC G02B 21/361; G01N 21/05; G02B 7/021; G02B 7/026; G02B 21/02

(57) ABSTRACT

A microscope imaging system includes an objective (18) configured to collect light from a biological sample (S) for forming a magnified image of the biological sample. The microscope imaging system also includes a camera (14) including an imaging sensor. The imaging sensor is configured to detect the magnified image of the biological sample. The microscope imaging system further includes a tube lens (16) positioned between the objective and the camera. The tube lens is configured to project the magnified image of the biological sample onto the imaging sensor of the camera. The tube lens is spaced apart from the imaging sensor of the camera by a distance (D2) less than a focal length of the tube lens.

### CROSS REFERENCE TO RELATED APPLICATIONS

This is a PCT International application of, and claims the benefit of priority to, U.S. provisional patent application 63/321,996, filed on Mar. 21, 2022, titled “Cover Glass Thickness Correction By Tube Lens Placement,” the disclosure of which is hereby incorporated by reference in its entirety.

### BACKGROUND

Various types of tests related to patient diagnosis and therapy can be performed by analysis of patient samples. This could include analysis of the patient's microorganisms, or “microbes,” as well as analysis of samples to determine chemistry, antigen, antibodies, blood cell count, particulates (e.g., sediment) and other factors that may influence patient health. Microbes are microscopic living organisms such as bacteria, fungi, or viruses, which may be single-celled or multicellular. When analyzing microbes, biological samples containing the patient's microorganisms may be taken from a patient's infections, bodily fluids, or abscesses and may be placed in test panels or arrays, combined with various reagents, incubated, and analyzed to aid in treatment of the patient. Analysis of patient chemistry, immunoassay, blood cell count, particulates, and other characteristics may be similarly performed. For these varying analyses, automated biochemical analyzers or biological testing systems have been developed to meet the needs of health care facilities and other institutions to facilitate analysis of patient samples and to improve the accuracy and reliability of results when compared to analysis using manual operations and aid in determining effectiveness of various antimicrobials.

Biological samples can be driven through a flowcell of a biological testing system for analysis. For example, such a testing system may include a microscope imaging system, which may be equipped with an imaging device such as a high-speed, high-resolution camera configured to image a biological sample (e.g., urine) as the biological sample passes through an analysis region of the flow cell. Such microscope imaging systems typically include an optical element known as an “objective” that collects light from the biological sample to form a magnified image of the sample, which may then be focused onto an imaging sensor of the camera at an image-forming plane via a tube lens, for example.

The medium between the biological sample and the objective impacts the manner in which the light is focused onto the image-forming plane and thus the quality of the image acquired by the camera. Many readily-available objectives are designed for imaging a sample through a standard microscope glass cover slip having a thickness of about 170 μm (e.g., 170 μm+/−5 μm). For example, such objectives may be configured to correct for any distortions that may otherwise be introduced by a 170 μm layer of glass. However, the thickness of a wall of a flowcell may be thicker for some applications (e.g., about 1 mm), such that optical performance with objectives designed for standard cover slips may be limited. This thickness may be desirable for providing sufficient strength to the flowcell for promoting reliable operation, such that reducing the thickness of the flowcell walls to more closely resemble the thickness of standard cover slips may not be practical. A specialized objective may thus be used to maintain the necessary optical performance for facilitating accurate imaging through a flowcell. For example, such a specialized objective may include a cover glass thickness adjustment mechanism, which undesirably adds significant cost and limits the selection of available products. Alternatively, such a specialized objective may be custom-designed and optimized for a particular set of requirements, which likewise undesirably adds significant cost. In other cases, cover glass correction add-on optics may be incorporated to mitigate the image quality degradation caused by cover glass thickness outside of the design range, thereby undesirably increasing the overall complexity of the optical system and also adding significant cost.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a schematic view of a biological analysis system including an exemplary microscope imaging system for imaging a sample through a cover slip;

FIG. 2 depicts an image acquired by the microscope imaging system of FIG. 1 through the cover slip of FIG. 1;

FIG. 3 depicts a schematic view of another biological analysis system including another exemplary microscope imaging system for imaging a sample through a flowcell wall;

FIG. 4 depicts a series of images acquired by the microscope imaging system of FIG. 3 through the flowcell wall of FIG. 3 with the tube lens of the microscope imaging system positioned at various distances from the camera of the microscope imaging system;

FIG. 5 depicts a schematic view of the biological analysis system of FIG. 3 with an exemplary oblique illumination system; and

FIG. 6 depicts a schematic view of another exemplary microscope imaging system for use with the biological analysis system of FIG. 3.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### SUMMARY

In some embodiments, a microscope imaging system is described. The microscope imaging system includes an objective configured to collect light from a biological sample for forming a magnified image of the biological sample. The microscope imaging system also includes a camera including an imaging sensor. The imaging sensor is configured to detect the magnified image of the biological sample. The microscope imaging system further includes a tube lens positioned between the objective and the camera. The tube lens is configured to project the magnified image of the biological sample onto the imaging sensor of the camera. The tube lens is spaced apart from the imaging sensor of the camera by a distance less than a focal length of the tube lens. In some embodiments, the objective includes an infinity corrected objective. In addition, or alternatively, the objective may be optimized for collecting the light from the biological sample through a cover slip having a thickness of about 170 μm. The focal length of the tube lens may be between about 50 mm and about 250 mm. In some embodiments, the distance by which the tube lens is spaced apart from the imaging sensor of the camera is less than about half of the focal length of the tube lens. In addition, or alternatively, the tube lens may be fixed against movement relative to the imaging sensor of the camera. The tube lens may be fixed against movement relative to the objective. In some embodiments, the objective is fixed against movement relative to the imaging sensor of the camera. In addition, or alternatively, the microscope imaging system may further include a lens casing, wherein the tube lens is housed within the lens casing. For example, the tube lens may be retained within the lens casing by at least one retention ring. In addition, or alternatively, the lens casing may include a first end configured to be coupled to the camera. The lens casing may also include a second end configured to be coupled to the objective. In addition, or alternatively, the lens casing may include first and second lens casing portions coupled to each other. The biological sample may be contained in a flowcell, and the objective may be configured to collect the light from the biological sample through a flowcell wall of the flowcell. In some embodiments, a biological analysis system includes the microscope imaging system and a flowcell configured to contain the biological sample, the flowcell including a flowcell wall. The objective is configured to collect the light from the biological sample through the flowcell wall. The flowcell wall may have a thickness of between about 0.2 mm and about 2 mm.

In some embodiments, a biological analysis system is described. The biological analysis system includes a flowcell configured to contain a biological sample. The flowcell includes a flowcell wall having a thickness of about 1 mm. The biological analysis system also includes a microscope imaging system, including an infinity-corrected objective configured to collect light from the biological sample through the flowcell wall for forming a magnified image of the biological sample. The microscope imaging system also includes a camera including an imaging sensor. The imaging sensor is configured to detect the magnified image of the biological sample. The microscope imaging system further includes a tube lens positioned between the infinity-corrected objective and the camera. The tube lens is configured to project the magnified image of the biological sample onto the imaging sensor of the camera. The tube lens is spaced apart from the imaging sensor of the camera by a distance less than a focal length of the tube lens. In some embodiments, the infinity-corrected objective is optimized for collecting the light from the biological sample through a cover slip having a thickness of about 170 μm. In addition, or alternatively, the focal length of the tube lens may be about 100 mm.

In some embodiments, a method of imaging a biological sample is described. The method includes collecting light from the biological sample via an objective and forming a magnified image of the biological sample via the objective. The method also includes projecting the magnified image of the biological sample onto an imaging sensor of a camera via a tube lens positioned between the objective and the camera. The tube lens is spaced apart from the imaging sensor of the camera by a distance less than a focal length of the tube lens. The method further includes detecting the magnified image of the sample via the imaging sensor of the camera. In some embodiments, the objective is optimized for collecting the light from the biological sample through a cover slip having a thickness of about 170 μm, and the act of collecting light includes collecting light from the biological sample through a flowcell wall having a thickness of about 1 mm.

In some embodiments, a microscope imaging system is described. The microscope imaging system includes an objective configured to collect light from a biological sample for forming a magnified image of the biological sample, and the biological sample is contained in a flowcell. The microscope imaging system also includes a camera comprising an imaging sensor, and the imaging sensor is configured to detect the magnified image of the biological sample. The microscope imaging system further includes a tube lens positioned between the objective and the camera. The tube lens is configured to project the magnified image of the biological sample onto the imaging sensor of the camera, and the tube lens is spaced apart from the imaging sensor of the camera by a distance less than a focal length of the tube lens.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

The terms “about,” “approximately,” and the like as used herein in connection with any numerical values or ranges of values are intended to encompass the exact value(s) referenced as well as a suitable tolerance that enables the referenced feature or combination of features to function for the intended purpose described herein.

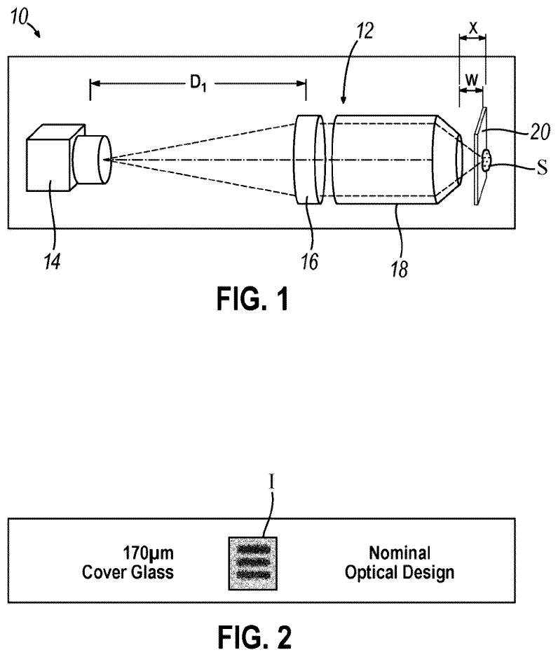

The present disclosure relates to apparatus, systems, compositions, and methods for analyzing biological samples. Exemplary biological analysis systems (10, 110) including exemplary microscope imaging systems (12, 112, 212) will be described in greater detail with reference to FIGS. 1-5.

### A. First Exemplary Biological Analysis System Embodiment Including First Exemplary Microscope Imaging System Embodiment

FIG. 1 shows at least a portion of an exemplary biological analysis system (10) that includes, among other components, an exemplary microscope imaging system (12). As shown, the microscope imaging system (12) includes an imaging device in the form of a camera (14), a tube lens (16), and an objective (18). The tube lens (16) may be housed within a lens casing or lens tube (not shown), which may be coupled to each of the camera (14) and the objective (18) to secure each of the camera (14), the tube lens (16), and the objective (18) at fixed positions relative to each other.

The microscope imaging system (12) is configured to image a biological sample, such as a urine sample (S), to facilitate analysis of the sample (S) by the biological analysis system (10). While imaging of a urine sample (S) is shown and described herein, the microscope imaging system (12) may image a variety of fluids including, but not limited to, other bodily fluids such as synovial fluid, blood, bone marrow, etc.

The objective (18) is configured to collect light from the sample (S) for forming a magnified image of the sample (S). In the embodiment shown, the objective (18) is configured to collect such light transmitted through a medium in the form of a glass cover slip (20) of the biological analysis system (10). More particularly, the cover slip (20) is of standard construction and has a thickness of about 170 μm. In this regard, the objective (18) may be configured to correct for any distortions that may otherwise be introduced by the cover slip (20) at least when the cover slip is spaced apart from the objective (18) by a predefined working distance (W) such that the sample (S) is spaced apart from the objective (18) by a distance (X) substantially equal to the sum of the working distance (W) and the thickness of the cover slip (20). For example, the objective (18) may include an optical train (not shown) configured to correct for any blurring of the image that may otherwise be introduced by the cover slip (20) when spaced apart from the objective (18) by the working distance (W). In addition, or alternatively, the thickness and material of cover slip (20) may be considered input parameters to the optical design of the objective (18), along with other parameters such as wavelength(s) of light and desired optical performance. It will be appreciated that the optical performance of an optical design can be very sensitive to the operating conditions and may degrade significantly even for small deviations from the optimal operating conditions. In the present example, the objective (18) is designed for operating optimally with the glass, 170 μm-thick cover slip (20) placed over the sample (S).

It will be appreciated that such optimization of the objective (18) for imaging through the cover slip (20) having a thickness of about 170 μm may render the objective (18) undesirable for imaging through cover slips having thicknesses substantially less than or substantially greater than about 170 μm and/or through other types of media, since the objective (18) may not appropriately correct for distortions introduced thereby or may otherwise result in degraded and/or suboptimal optical performance. Thus, the objective (18) may be specifically designated for imaging through cover slips (20) spaced apart from the objective (18) by the predefined working distance (W) and having a thickness of about 170 μm. In addition, or alternatively, the objective (18) may be configured as an infinity-corrected objective (also referred to as an “infinite back focal length objective”) such that light exiting the objective (18) may be focused at infinity. By way of example, the objective (18) may include the CFI Achromat LWD 20X 0.40 NA objective sold by Nikon®, which has a working distance (W) of about 3.90 mm. It will be appreciated that any other suitable type of objective may be used, such as an objective having a similar magnification and similar working distance to that of the CFI Achromat LWD 20X 0.40 NA objective sold by Nikon®.

The tube lens (16) is positioned between the objective (18) and the camera (14), such that the tube lens (16) is configured to project the magnified image of the sample (S) onto an imaging sensor (not shown) of the camera (14). In some embodiments, the tube lens (16) may have a focal length of between about 50 mm and about 250 mm, such as between about 100 mm and about 200 mm. For example, the tube lens (16) may have a focal length of between about 80 mm and about 120 mm, or between about 90 mm and 110 mm. In one example, the tube lens (16) has a focal length of about 100 mm. In any event, the imaging sensor of the camera (14) is configured to detect the image of the sample (S) focused thereon by the tube lens (16) after being magnified by the objective (18). The camera (14) may be in operative communication with a processor (not shown) for facilitating transmission of signals therebetween. For example, such a processor may be configured to transmit command signals to the camera (14), such as for initiating acquisition of one or more image(s) by the camera (14), and/or to receive data signals from the camera (14) corresponding to the acquired image(s).

As shown in FIG. 1, the tube lens (16) of the microscope imaging system (12) is spaced apart from the imaging sensor of the camera (14) by a first distance (D1) substantially equal to the focal length of the tube lens (16) such that the position of the imaging sensor of the camera (14) may substantially coincide with the focal point of the tube lens (16). For example, the first distance (D1) may be about 100 mm in cases where the tube lens has a focal length of about 100 mm. Such positioning of the tube lens (16) relative to the imaging sensor of the camera (14) may define a nominal design configuration of the microscope imaging system (12) wherein the objective (18) is optimized for use with the cover slip (20) having a thickness of about 170 μm, since the tube lens (16) may form a properly focused image of the sample (S) at the focal point of the tube lens (16) for acquisition by the imaging sensor of the camera (14). An example of such a properly focused image (I) acquired by the camera (14) is shown in FIG. 2. The image (I) shown in FIG. 2 is of a resolution target pattern with 228 line pairs per millimeter imaged using the objective (18) with the microscope imaging system (12) in the nominal design configuration. It will be appreciated that altering the distance between the tube lens (16) and the camera (14) from the nominal design configuration may degrade the quality of the image (I) acquired by the camera (14) through the cover slip (20).

### B. Second Exemplary Biological Analysis System Embodiment Including Second Exemplary Microscope Imaging System Embodiment

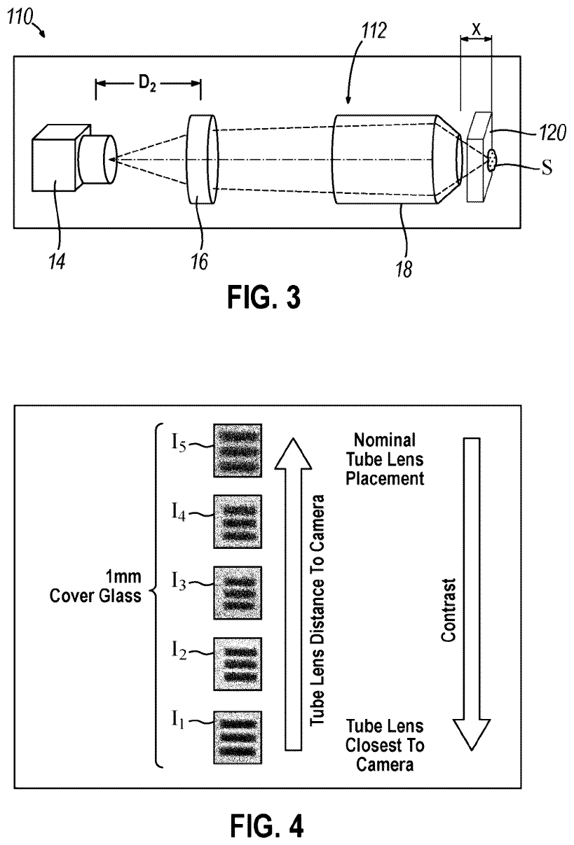

FIG. 3 shows at least a portion of another exemplary biological analysis system (110) that includes, among other components, another exemplary microscope imaging system (112). The microscope imaging system (112) is structurally and functionally similar to the microscope imaging system (12) described above, except as otherwise described below. In this regard, the microscope imaging system (112) includes the camera (14), the tube lens (16), and the objective (18) described above in connection with FIG. 1. The tube lens (16) may be housed within a lens casing or lens tube (not shown), which may be coupled to each of the camera (14) and the objective (18) to secure each of the camera (14), the tube lens (16), and the objective (18) at fixed positions relative to each other.

As described above, the objective (18) is optimized for imaging through the glass cover slip (20) having a thickness of about 170 μm. However, in the embodiment shown, the objective (18) is used to collect light from the sample (S) that is transmitted through a medium in the form of a glass flowcell wall (120) of the biological analysis system (110), where the glass flowcell wall (120) acts like a glass cover slip (20) in terms of transmitting light. More particularly, the flowcell wall (120) has a thickness of between about 0.2 mm and about 2 mm, about 0.5 mm to about 1.5 mm, about 0.8 mm to about 1.2 mm, or about 1 mm. The increase of glass flowcell wall thickness to one that is thicker than 170 μm (e.g., between about 0.2 mm and about 2 mm, or about 1 mm) can be helpful to increase the structural strength to address system pressures and reduce or eliminate the chance of the glass breaking. Due to the substantial increase in thickness of the flowcell wall (120) relative to that of the cover slip (20), the objective (18) may not be configured to correct for the distortions introduced by the flowcell wall (120) or may otherwise be expected to result in degraded and/or suboptimal optical performance. Moreover, the flowcell wall (120) may be spaced apart from the objective (18) by a distance less than the working distance (W) of the objective (18) to allow the sample (S) to be spaced apart from the objective (18) by the same distance (X) described above in connection with FIG. 1. Thus, the sample (S) may be spaced apart from the objective (18) by a distance greater than the nominal working distance (W) of the objective (18). In some cases, the distance by which the sample (S) is spaced apart from the objective (18) may be determined using the following equation:

$$X = W + D * ( 1 - n 1 / n 2 )$$

where:
X is the distance by which the sample (S) is spaced apart from the objective (18);
W is the working distance of the objective (18);
D is the thickness of the flowcell wall (120);
n1 is the refractive index of air; and
n2 is the refractive index of the flowcell wall (120) (e.g., glass).

As a result, the objective (18) may focus on a point which is substantially farther than the specimen(S), since the greater thickness of the flowcell wall (120) relative to the cover slip (20) may cause the focal point to shift farther from the objective (18). Rather than the objective (18) being specially reconfigured to correct for any distortions that may otherwise be introduced by the flowcell wall (120) and/or by its spacing relative to the objective (18), the spacing between the imaging sensor of the camera (14) and the tube lens (16) is adjusted away from the nominal design configuration shown in FIG. 1 to correct for such distortions.

In this regard, the tube lens (16) of the microscope imaging system (12) is spaced apart from the imaging sensor of the camera (14) by a second distance (D2) substantially less than the focal length of the tube lens (16) such that the position of the imaging sensor of the camera (14) may be between the focal point of the tube lens (16) and the tube lens (16) itself. For example, the second distance (D2) may be substantially less than 100 mm in cases where the tube lens has a focal length of about 100 mm. In some embodiments, the second distance (D2) may be about half of the focal length of the tube lens (16). For example, the second distance (D2) may be about 50 mm in cases where the tube lens has a focal length of about 100 mm. In some embodiments, the second distance (D2) by which the tube lens (16) of the microscope imaging system (12) is spaced apart from the imaging sensor of the camera (14) may be determined according to the below table.

| | | | Working |
|---|---|---|---|
| Tube length | Lens position from | | Distance |
| (mm) | camera sensor (mm) | Objective | (mm) |
| 114.3 | 27.306 | 20x 0.4 NA | 3.9 |
| 114.3 | 31.32 | 20x 0.4 NA | 3.9 |
| 114.3 | 42.926 | 20x 0.4 NA | 3.9 |
| 114.3 | 68.326 | 20x 0.4 NA | 3.9 |
| 114.3 | 93.726 | 20x 0.4 NA | 3.9 |
| 114.3 | 27.306 | 20x 0.4 NA | 3.1 |
| 114.3 | 31.32 | 20x 0.4 NA | 3.1 |
| 114.3 | 42.926 | 20x 0.4 NA | 3.1 |
| 114.3 | 68.326 | 20x 0.4 NA | 3.1 |
| 114.3 | 93.726 | 20x 0.4 NA | 3.1 |
| 152.4 | 27.306 | 20x 0.4 NA | 3.9 |
| 152.4 | 31.32 | 20x 0.4 NA | 3.9 |
| 152.4 | 42.926 | 20x 0.4 NA | 3.9 |
| 152.4 | 68.326 | 20x 0.4 NA | 3.9 |
| 152.4 | 93.726 | 20x 0.4 NA | 3.9 |
| 152.4 | 119.126 | 20x 0.4 NA | 3.9 |
| 152.4 | 27.306 | 20x 0.4 NA | 3.1 |
| 152.4 | 31.32 | 20x 0.4 NA | 3.1 |
| 152.4 | 42.926 | 20x 0.4 NA | 3.1 |
| 152.4 | 68.326 | 20x 0.4 NA | 3.1 |
| 152.4 | 93.726 | 20x 0.4 NA | 3.1 |
| 152.4 | 119.126 | 20x 0.4 NA | 3.1 |
| 63.5 | 27.306 | 20x 0.4 NA | 3.9 |
| 63.5 | 31.32 | 20x 0.4 NA | 3.9 |
| 63.5 | 42.926 | 20x 0.4 NA | 3.9 |
| 63.5 | 27.306 | 20x 0.4 NA | 3.1 |
| 63.5 | 31.32 | 20x 0.4 NA | 3.1 |
| 63.5 | 42.926 | 20x 0.4 NA | 3.1 |
| 50.8 | 27.306 | 20x 0.4 NA | 3.9 |
| 50.8 | 31.32 | 20x 0.4 NA | 3.9 |
| 50.8 | 42.926 | 20x 0.4 NA | 3.9 |
| 50.8 | 27.306 | 20x 0.4 NA | 3.1 |
| 50.8 | 31.32 | 20x 0.4 NA | 3.1 |
| 50.8 | 42.926 | 20x 0.4 NA | 3.1 |

Such positioning of the tube lens (16) relative to the imaging sensor of the camera (14) may substantially deviate from the nominal design configuration of the microscope imaging system (12) wherein the objective (18) is optimized for use with the cover slip (20) having a thickness of about 170 μm. However, this deviation may correct for the distortions introduced by the increased thickness of the flowcell wall (120) relative to the cover slip (20), thereby enabling the imaging sensor of the camera (14) to acquire an image having improved quality relative to an image that would otherwise be acquired through the flowcell wall (120) with the microscope imaging system (12) in the nominal design configuration of FIG. 1. Examples of such images (a) acquired by the camera (14) with the tube lens (16) at various positions are shown in FIG. 4. The distances by which the tube lens (16) is spaced apart from the imaging sensor of the camera (14) are listed in the below table.

| Tube | | | | |
|---|---|---|---|---|
| length | Lens position from | | Working | |
| (mm) | camera sensor (mm) | Objective | Distance (mm) | Image |
| 114.3 | 27.306 | 20x 0.4 NA | 3.9 | I₁ |
| 114.3 | 31.32 | 20x 0.4 NA | 3.9 | I₂ |
| 114.3 | 42.926 | 20x 0.4 NA | 3.9 | I₃ |
| 114.3 | 68.326 | 20x 0.4 NA | 3.9 | I₄ |
| 114.3 | 93.726 | 20x 0.4 NA | 3.9 | I₅ |

The images (I₁, I₂, I₃, I₄, I₅) shown in FIG. 4 are of a resolution target pattern with 228 line pairs per millimeter imaged using the objective (18) with the microscope imaging system (12) not in the nominal design configuration. More particularly, the first image (I₁) corresponds to the tube lens (16) being at or near the position shown in FIG. 3, the fifth image (I₅) corresponds to the tube lens (16) being at a position closer to that shown in FIG. 1, and the second, third, and fourth images (I₂, I₃, I₄) correspond to the tube lens (16) being at positions therebetween. As shown, decreasing the distance between the tube lens (16) and the camera (14) relative to the nominal design configuration may improve, rather than degrade, the quality of the image (I₁, I₂, I₃, I₄, I₅) acquired by the camera (14) through the flowcell wall (120). More particularly, the illustrated images (I₁, I₂, I₃, I₄, I₅) indicate that the image contrast generally increases as the tube lens (16) is moved closer to the camera (14) from the nominal placement of the tube lens (16) in the nominal design configuration, such that the quality of the first image (I₁) acquired with the tube lens (16) positioned closest to the camera (14) is better than the quality of the fifth image (I₅) acquired with the tube lens (16) positioned farthest from the camera (14) (e.g., at or near the nominal placement of the tube lens (16) in the nominal design configuration). In the example shown, the quality of the second image (I₂) may be the most preferred (e.g., when the second distance (D2) is about 31.32 mm), with the quality of the first image (I₁) slightly degrading relative to the quality of the second image (I₂). In some embodiments, the optimal image quality may be achieved when the second distance (D2) is between about a quarter of the focal length of the tube lens (16) and about a half of the focal length of the tube lens (16), such as about a third of the focal length of the tube lens (16).

In some embodiments, the spacing between the imaging sensor of the camera (14) and the tube lens (16) may be further adjusted away from the nominal design configuration to correct for any distortions that may be introduced by a fluid film layer between the sample (S) and the flowcell wall (120) through which the light is transmitted. For example, such a fluid film layer may have a thickness of about 80 μm.

Thus, the objective (18) originally optimized for imaging through the cover slip (20) having a thickness of about 170 μm may be incorporated into the microscope imaging system (112) and used for facilitating accurate imaging of the sample (S) through the flowcell wall (120) having a thickness of about 1 mm, without specially reconfiguring the objective (18) itself or adding additional components, complexity, or cost relative to the microscope imaging system (12). While the microscope imaging system (112) has been described for imaging the sample (S) through the flowcell wall (120) having a thickness of between about 0.2 mm and about 2 mm (e.g., about 1 mm) (and/or through a fluid film layer having a thickness of about 80 μm), it will be appreciated that the microscope imaging system (112) may be used for imaging the sample (S) through any other type of medium. For example, the microscope imaging system (112) may be used for imaging the sample (S) through a glass cover slip (not shown) having a thickness of between about 0.2 mm and about 2 mm (e.g., about 1 mm). In addition, or alternatively, the microscope imaging system (112) may be used for imaging the sample (S) through a dish (not shown) containing the sample (S) and having a thickness of between about 0.2 mm and about 2 mm (e.g., about 1 mm).

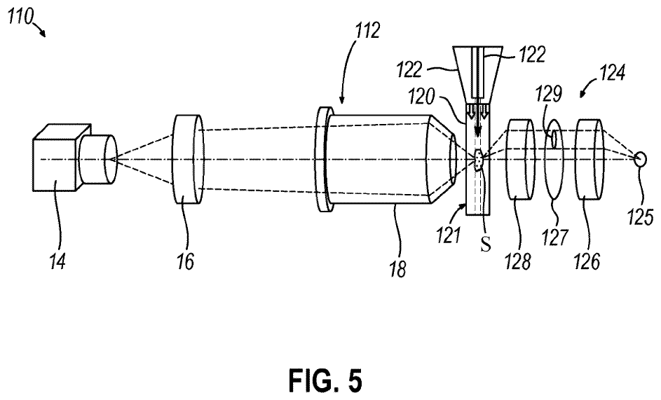

FIG. 5 shows exemplary additional components of the biological analysis system (110). In the embodiment shown, the above-described flowcell wall (120) is incorporated into a flowcell (121) which receives the sample (S) and/or additional fluid(s) (e.g., a surrounding sheath fluid) from one or more conduits (122) of the biological analysis system (110) that are positioned upstream relative to the flowcell (121).

As shown, an oblique illumination system (124) is positioned on a side of the flowcell (121) opposite the microscope imaging system (112) along an optical axis thereof for illuminating the sample (S) to facilitate the capturing of images of the sample (S) by the microscope imaging system (112). In the example shown, the oblique illumination system (124) includes a light emitter (125), a collector lens (126), an aperture mask (127), and a condenser lens (128). The light emitter (125) may be any suitable light source including, for example, an arc lamp, a light emitting diode (LED), or any other suitable light emitter for providing either pulsed or continuous illumination. The collector lens (126) may be any suitable collector lens for collecting the light emitted from the light emitter (125) and uniformly transmitting the light onto the aperture mask (127). In this regard, the aperture mask (127) may be opaque, and may block light from the collector lens (126) everywhere but through an off-center aperture (129) thereof, such that light transmitted through the aperture (129) reaches the condenser lens (128) off-center from the optical axis. The condenser lens (128) may be any suitable condenser lens for angling the light received toward the sample (S), so that the sample (S) is illuminated with light at an oblique angle.

### C. Third Exemplary Microscope Imaging System Embodiment

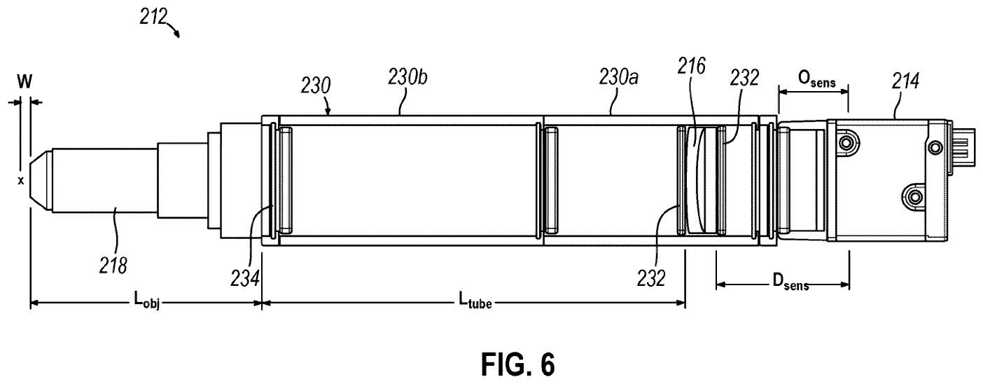

FIG. 6 shows another exemplary microscope imaging system (212) for use with a biological analysis system, such as the biological analysis system (110). The microscope imaging system (212) is structurally and functionally similar to the microscope imaging system (112) described above, except as otherwise described below. In this regard, the microscope imaging system (212) includes a camera (214), a tube lens (216), and an objective (218) similar to the objective (18) described above in connection with FIGS. 1 and 3 and having an objective length (L_{obj}) and working distance (W). In some versions, the objective length (L_{obj}) may be about 2.212 inches. In addition, or alternatively, the working distance (W) may be about 0.154 inch. The tube lens (216) is housed within a lens casing or lens tube (230), which is coupled to the camera (214) at or near a first (e.g., proximal) end of the lens tube (230). The lens tube (230) is coupled to the objective (218) at or near a second (e.g., distal) end of the lens tube (230) to secure each of the camera (214), the tube lens (216), and the objective (218) at fixed positions relative to each other.

In the embodiment shown, the lens tube (230) includes a first (e.g., proximal) lens tube portion (230a) and a second (e.g., distal) lens tube portion (230b) coupled to each other. The tube lens (216) is housed within the first lens tube portion (230a) proximate to the camera (214) and is spaced apart from a distal end of the second lens tube portion (230b) by a tube lens effective length (L_{tube}). In some versions, the tube lens effective length (L_{tube}) may be about 4.049 inches. In any event, the tube lens (216) is spaced apart from an imaging sensor (not shown) of the camera (214) by a distance substantially less than the focal length of the tube lens (216) such that the position of the imaging sensor of the camera (214) may be between the focal point of the tube lens (216) and the tube lens (216) itself. In the example shown, the imaging sensor of the camera (214) is spaced apart from a flange or other mating surface of the camera (214) by a sensor offset (Oₛₑₙₛ), and is spaced apart from the tube lens (216) by a sensor distance (Dₛₑₙₛ). In some versions, the sensor distance (Dₛₑₙₛ) may be about 1.233 inches, such as in cases where the focal length of the tube lens (216) is about 100 mm. In addition, or alternatively, the sensor offset (Oₛₑₙₛ) may be about 0.690 inch. As shown, the tube lens (216) is securely retained within the first lens tube portion (230a) by a pair of lens retention rings (232).

The second lens tube portion (230b) is configured to be coupled to the objective (218). In this regard, the second lens tube portion (230b) includes a coupling mechanism (234), such as a thread or a socket, configured to mate with a corresponding coupling mechanism of the objective (218) to thereby couple the objective (218) to the second lens tube portion (230b). In some embodiments, the objective (218) may be at least partially received within the second lens tube portion (230b). In addition, or alternatively, the objective (218) may at least partially extend away (e.g., distally) from the second lens tube portion (230b). In any event, the objective (218) may be optimized for imaging through the glass cover slip (20) having a thickness of about 170 μm as described above. Nevertheless, the objective (218) may be incorporated into the microscope imaging system (212) and used for facilitating accurate imaging of the sample (S) through the flowcell wall (120) or a glass cover slip/dish having a thickness of about 1 mm due to the positioning of the tube lens (216) relative to the imaging sensor of the camera (214), in a manner similar to that described above in connection with FIG. 3.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. In certain cases, method steps or operations may be performed or executed in differing order, or operations may be added, deleted or modified. It can be appreciated that, in certain aspects of the invention, a single component may be replaced by multiple components, and multiple components may be replaced by a single component, to provide an element or structure or to perform a given function or functions. Except where such substitution would not be operative to practice certain embodiments of the invention, such substitution is considered within the scope of the invention. Accordingly, the present invention is not limited to the embodiments described above or depicted in the drawings, and various embodiments and modifications can be made without departing from the scope of the claims below.

1. A microscope imaging system comprising:
(a) an objective configured to collect light from a biological sample for forming a magnified image of the biological sample;
(b) a camera comprising an imaging sensor, wherein the imaging sensor is configured to detect the magnified image of the biological sample; and
(c) a tube lens positioned between the objective and the camera, wherein the tube lens is configured to project the magnified image of the biological sample onto the imaging sensor of the camera, wherein the tube lens is spaced apart from the imaging sensor of the camera by a distance less than a focal length of the tube lens.

2. The microscope imaging system of claim 1, wherein the objective comprises an infinity corrected objective.

3. The microscope imaging system of claim 1, wherein the objective is optimized for collecting the light from the biological sample through a cover slip having a thickness of about 170 μm.

4. The microscope imaging system of claim 1, wherein the focal length of the tube lens is between about 50 mm and about 250 mm.

5. The microscope imaging system of claim 1, wherein the distance by which the tube lens is spaced apart from the imaging sensor of the camera is less than about half of the focal length of the tube lens.

6. The microscope imaging system of claim 1, wherein the tube lens is fixed against movement relative to the imaging sensor of the camera.

7. The microscope imaging system of claim 1, wherein the tube lens is fixed against movement relative to the objective.

8. The microscope imaging system of claim 1, wherein the objective is fixed against movement relative to the imaging sensor of the camera.

9. The microscope imaging system of claim 1, further comprising a lens casing, wherein the tube lens is housed within the lens casing.

10. The microscope imaging system of claim 9, wherein the tube lens is retained within the lens casing by at least one retention ring.

11. The microscope imaging system of claim 9, wherein the lens casing includes a first end configured to be coupled to the camera.

12. The microscope imaging system of claim 11, wherein the lens casing includes a second end configured to be coupled to the objective.

13. The microscope imaging system of claim 9, wherein the lens casing includes first and second lens casing portions coupled to each other.

14. The microscope imaging system of claim 1, wherein the biological sample is contained in a flowcell, and wherein the objective is configured to collect the light from the biological sample through a flowcell wall of the flowcell.

15. A biological analysis system, comprising:
(a) the microscope imaging system of claim 1; and
(b) a flowcell configured to contain the biological sample, wherein the flowcell includes a flowcell wall, wherein the objective is configured to collect the light from the biological sample through the flowcell wall.

16. The biological analysis system of claim 15, wherein the flowcell wall has a thickness of between about 0.2 mm and about 2 mm.

17. A biological analysis system, comprising:
(a) a flowcell configured to contain a biological sample, wherein the flowcell includes a flowcell wall having a thickness of about 1 mm; and
(b) a microscope imaging system, comprising:
(i) an infinity-corrected objective configured to collect light from the biological sample through the flowcell wall for forming a magnified image of the biological sample,
(ii) a camera comprising an imaging sensor, wherein the imaging sensor is configured to detect the magnified image of the biological sample, and
(iii) a tube lens positioned between the infinity-corrected objective and the camera, wherein the tube lens is configured to project the magnified image of the biological sample onto the imaging sensor of the camera, wherein the tube lens is spaced apart from the imaging sensor of the camera by a distance less than a focal length of the tube lens.

18. The biological analysis system of claim 17, wherein the infinity-corrected objective is optimized for collecting the light from the biological sample through a cover slip having a thickness of about 170 μm.

19. A method of imaging a biological sample, the method comprising:
(a) collecting light from the biological sample via an objective;
(b) forming a magnified image of the biological sample via the objective;
(c) projecting the magnified image of the biological sample onto an imaging sensor of a camera via a tube lens positioned between the objective and the camera, wherein the tube lens is spaced apart from the imaging sensor of the camera by a distance less than a focal length of the tube lens; and
(d) detecting the magnified image of the sample via the imaging sensor of the camera.

20. The method of claim 19, wherein the objective is optimized for collecting the light from the biological sample through a cover slip having a thickness of about 170 μm, wherein the act of collecting light comprises collecting light from the biological sample through a flowcell wall having a thickness of about 1 mm.
